(19) United States
(12) Patent Application Publication
(10) Pub. No.: US 2023/0397543 A1
(43) Pub. Date: Dec. 14, 2023

(54) GREENHOUSE SCREEN WITH ANTIFOGGING EFFECT

(71) Applicant: AB Ludvig Svensson, Kinna (SE)

(72) Inventors: Daniel ASPLUND, Landvetter (SE); Stefan ALMSTRÖM, Kinnarumma (SE)

(21) Appl. No.: 18/249,115

(22) PCT Filed: Oct. 15, 2021
(86) PCT No.: PCT/EP2021/078593

§ 371 Date: Apr. 14, 2023

(30) Foreign Application Priority Data
Oct. 16, 2020 (SE) 2051206-7

(51) Int. Cl. A01G 9/22; A01G 9/14; B32B 27/36; B32B 27/08; B32B 27/18; C09D 5/16; C09D 129/04; C09D 7/61; C09D 7/63

(52) U.S. Cl. CPC A01G 9/22; A01G 9/1438; B32B 27/36; B32B 27/08; B32B 27/18; C09D 5/1662; C09D 129/04; C09D 7/61; C09D 7/63; A01G 2009/1461; A01G 2009/1453; B32B 2250/244; B32B 2250/03; B32B 2255/10; B32B 2255/26; B32B 2270/00; B32B 2307/412; B32B 2307/414; B32B 2307/7376; B32B 2264/1021; B32B 2272/00; C08K 5/353

(57) ABSTRACT

The present invention relates to greenhouse screens comprising strips of film material that are interconnected by a yarn system of longitudinal threads and transverse threads by means of a knitting, warp-knitting or weaving process to form a continuous product. At least 50% of the strips comprise a single- or multi-layer polyester film having a transparency of at least 92%, wherein the polyester film has a first and a second surface, wherein a permanent antifog coating has been applied to at least one of the first or second surfaces of the polyester film. The antifog coating comprises at least one water-soluble polymer, an inorganic hydrophilic material and a crosslinker, wherein the water-soluble polymer is a polyvinyl alcohol or a hydrophilic amorphous copolymer. Furthermore, the present disclosure relates to production processes of the coated polyester film and its use for the production of energy-saving screens having excellent antifogging effect in greenhouses.

### FIELD OF INVENTION

The present invention relates to a greenhouse screen comprising strips of a mono- or multilayer, highly transparent, biaxially oriented, UV-stable polyester film which is provided with a permanent antifog coating on at least one side. The greenhouse screen has special transparency as well as permanent antifog properties and high UV stability. The invention further relates to a process to manufacture the polyester film of the greenhouse screen and its use in greenhouses.

### BACKGROUND

Greenhouse shading nets or screens in greenhouses must fulfill a range of requirements. They must provide a high light transmission in the photosynthetic wavelength range, as this is required by the plants for optimal plant growth. If possible, light transmission should not be affected by weather conditions wherein condensation forms on the shading screens.

Due to the typically high humidity in greenhouses, under normal weather conditions (e.g., temperature differences between day and night) condensation water forms in the form of water droplets, especially on the surface of the greenhouse shading screens facing the plants. In addition to weather conditions, also different surface tensions of water and plastic promote the formation of condensation. In these situations, films provided with antifog properties may prevent the formation of water droplets and thereby enable a fog-free view through the plastic film.

In general, antifog additives can be incorporated into the polymer matrix during the extrusion process of the film or applied to the polymer matrix as a coating. Such antifog additives are generally bivalent compounds that have a non-polar aliphatic region for anchoring in the polymer matrix and a polar hydrophilic part that can interact with water and reduce the surface tension of water droplets so that a continuous transparent film of water (due to a hydrophilic surface) is formed on the film.

In contrast to a liquid film, water droplets have a high light-scattering and increased reflective effect, which leads to significantly lower photosynthesis, especially in the morning hours with little light. In addition, the rotting of plants and plant parts due to non-adhesive or dripping water droplets is prevented and the burning of plants and plant parts due to droplets acting like a burning lens on the film surface when light falls on them is reduced. If droplets are nevertheless formed when condensation is very strong, the antifog component must not contain any toxic or particularly environmentally harmful substances. Among the undesirable substances, alkylphenol ethoxylates, which are frequently used in antifog systems (e.g., WO 1995018210), should be mentioned. Furthermore, it would be desirable for the greenhouse screens to have a UV stability that allows them to be used in a greenhouse for at least 5 years without significant yellowing, showing brittleness or cracking on the surface and/or a serious reduction in the mechanical properties or significant loss of transparency.

The use of antifog additives in films should not negatively influence the light transmission and hence the transparency of the greenhouse screens in order to avoid a decrease in the harvest yield. Greenhouse screens made from polyester films with various transparent antifog coatings are well known. For example, surface-active coatings based on hydrophilic water-soluble polymers and/or surfactants are used to coat the surfaces of plastic films to achieve an antifog effect.

A fundamental problem of water-soluble polymers and/or surfactants is that the coating is easy to wash off, which means that a permanent antifog effect cannot be achieved. Common polyester films with antifog coatings are described in EP 1647568 B1 and EP 1777251 B1. These polyester films have good mechanical properties but show a lower transparency. Furthermore, they have a lower long-term stability under weathering. In addition, the antifog effect of these polyester films has only a short life span of a few months, because the corresponding antifog additives are easily washed off and are soluble in water, so that the active substance is quickly used up when used as a greenhouse screen. EP 1152027 A1, EP 1534776 A1 and EP 2216362 A1 describe polyolefin films based on low density polyethylene (LDPE), or films based on polyvinyl chloride (PVC) and ethylene vinyl acetate (EVA) with long-lasting antifog properties for food packaging, and greenhouse applications using antifog additives based on inorganic hydrophilic colloidal substances (colloidal silicon, aluminum and others), and non-ionic, anionic or cationic surface-active additives. These films show permanent antifog properties, but in contrast to polyester-based greenhouse screens, they have greatly reduced mechanical properties. The use of polyolefin-based films can be categorically excluded for the target application, as the desired long-term stability and consequently, the long-term service life of 5 years cannot be realized due to the faster UV degradation of polyethylene (PE) compared to polyethylene terephthalate (PET), which has a negative effect on their economic efficiency. In addition, the lower mechanical stability of polyolefins causes the screens to stretch and lose their largely closed structure, resulting in a lower insulation effect.

EP3456762A2 reveals a polyester film with a permanent antifog coating based on a porous material, a polymer-based organic crosslinker, organofunctional silane and one or more surfactants, which is suitable for further processing as a greenhouse screen. The antifog properties of these films in terms of permanence are good and the transparency achievable is within the desired range. Nevertheless, these films show a need for improvement in the quality of the antifog effect, especially at higher coating thicknesses. Furthermore, the use of organofunctional silanes is problematic and undesirable for regulatory reasons, so that this solution must also be excluded.

The state-of-the-art films used in greenhouse screens are disadvantageous because their antifog properties are not long-lasting or the antifog coating is applied to the films in an additional process step. Furthermore, state-of-the-art polyester films are disadvantageous because they do not have a sufficient permanent antifog coating in combination with high transparency and long-term stability.

### SUMMARY OF THE INVENTION

An object of the present invention is to overcome or ameliorate at least some of the disadvantages of prior art screens, or to provide a useful alternative. The above object may be achieved with a greenhouse screen in accordance with claim 1 and a method for producing the film of said greenhouse screen. Further embodiments are set out in the dependent claims, the description and in the drawings.

As set out herein there is provided a greenhouse screen comprising a polyester film which exhibits permanent antifog properties combined with a high transparency of at least 92%, UV stability of at least 5 years without significant yellowing and without showing any embrittlement or cracking of the surface or deterioration of the mechanical and optical properties critical for the application. The film of the greenhouse screen is also economically producible in the thickness range of from 10 to 40 μm on existing single or multi-layer polyester film lines.

The object is solved by providing a greenhouse screen comprising strips of a film material that are interconnected by a yarn system of transverse threads and longitudinal threads by means of a knitting, warp-knitting or weaving process to form a continuous product. At least 50% of the strips consist of a single- or multilayer coated polyester film, having a transparency of at least 92%. The polyester film has a first and a second surface and a permanent antifog coating has been applied to at least one of the surfaces of the polyester film. The antifog coating comprises
a) at least one water-soluble polymer;
b) an inorganic, hydrophilic material and
c) a crosslinker,
   wherein the water-soluble polymer is a polyvinyl alcohol copolymer or a hydrophilic amorphous copolymer.

The inorganic hydrophilic material is advantageously fumed silica, colloidal silica or alumina, and the crosslinker is advantageously based on an oxazolin-modified polymer or other crosslinkers.

The polyester film comprises a base layer (B) and optionally a first cover layer (A), or a first cover layer (A) and a second cover layer (C). If present, the first cover layer (A) is applied onto a first or the second surface of the base layer (B) and, if present, the second cover layer (C) is applied to the surface of the base layer (B) opposite the first cover layer (A).

A layer in the sense of the present invention is a polymer layer formed by coextrusion. That is, the polyester film according to the present invention is formed by one or more layer(s).

A coating in the sense of the present invention is the drying product of an aqueous dispersion applied to the polyester film and is not part of the extrusion process of the polyester film per se. The coating is applied onto the surface of the single- or multilayered film.

The biaxially oriented polyester film (not including the coating) advantageously has a thickness of 10-40 μm, preferably 14-23 μm and most preferably 14.5-20 μm.

The base layer (B) is advantageously at least 70% by weight. % of a thermoplastic polyester, wherein the thermoplastic polyester consists of at least 90 mol %, preferably at least mol % of units derived from ethylene glycol and terephthalic acid, or units derived from ethylene glycol and naphthalene-2,6-dicarboxylic acid.

Advantageously the polyester film contains particles to achieve a certain roughness of the surface and to improve on the winding properties of the film. The particles are selected from the group consisting of calcium carbonate, amorphous silica, talc, magnesium carbonate, barium carbonate, calcium sulfate, barium sulfate, lithium phosphate, calcium phosphate, magnesium phosphate, aluminum oxide, lithium fluoride, calcium, barium, zinc or manganese salts of the dicarboxylic acids used, titanium dioxide, kaolin or particulate polymers such as, for example, crosslinked polystyrene or acrylate particles. Preferably amorphous silica is used as particles. The particles are preferably used in a concentration of less than 0.5 wt. % based on the total weight of the film. Preferably the particles are present in the cover layers (A) and/or (C), but if the film has a multilayer structure, the particles can be present in all layers.

The base layer (B), and if present, the cover layers (A) and (C) advantageously comprise a UV stabilizer.

The UV stabilizer is selected from the group consisting of triazines, benzotriazoles, and benzoxazinones, wherein triazines are preferred. The base layer (B), and if present, the cover layers (A) and (C) comprise the UV stabilizer in an amount of from 0.3 to 3 wt. %, preferably from 0.75 to 2.8 wt. %, based on the total weight of the respective layer.

The antifog coating has a lower refractive index than the polyester film and a thickness of at least 60 nm and at most 150 nm, preferably at least 70 nm and at most 130 nm, particularly preferably of at least 80 nm and at most 120 nm.

An advantage of the present invention is that the antifog coating according to the invention is free from organofunctional silanes that promote adhesion. Adhesion-promoting organofunctional silanes are for example vinyltrimethoxysilane, vinyltriethoxysilane, γ-methacryloxy-propyl-trimethoxysilane, or γ-glycidoxypropyltrimethoxysilane. Such silanes are suspected to have a cancerogenic effect and should therefore be avoided.

The antifog coating is applied to the first or the second surfaces of the polyester film and advantageously the surface of the polyester film opposite the antifog coating has an antireflection modification which
a) is an antireflective coating, or
b) is a top layer modification.

The top layer modification is formed by co-extrusion onto the base layer (B), and the top layer modification comprises a polyester having a lower refractive index than the polyester of the base layer (B). When applied on a surface opposite to an antireflection modification the antifog coating has a thickness of at least 30 nm, preferably at least 40 nm, particularly preferably at least 50 nm and at most 150 nm.

The coated polyester film of the greenhouse screen is produced by extrusion and biaxial stretching, and by either
a) applying the antifog coating composition wet to the polyester film in-line before the coated polyester film is thermoset and wound up, or
b) thermosetting and winding the polyester film onto a take-off roll before applying the antifog coating composition to the polyester film off-line by means of conventional coating technology, and subsequently drying and winding the polyester film.

### BRIEF DESCRIPTION OF THE DRAWINGS

Example arrangements of greenhouse screens are described hereinafter with reference to the accompanying drawings.

FIG. 1 shows on an enlarged scale a part of warp-knitted screen according to one embodiment.

FIG. 2 shows a part of a warp-knitted screen according to another embodiment.

FIG. 3 shows on an enlarged scale a part of a woven screen.

FIG. 4 shows a part of a woven screen according to a further embodiment.

### DETAILED DESCRIPTION

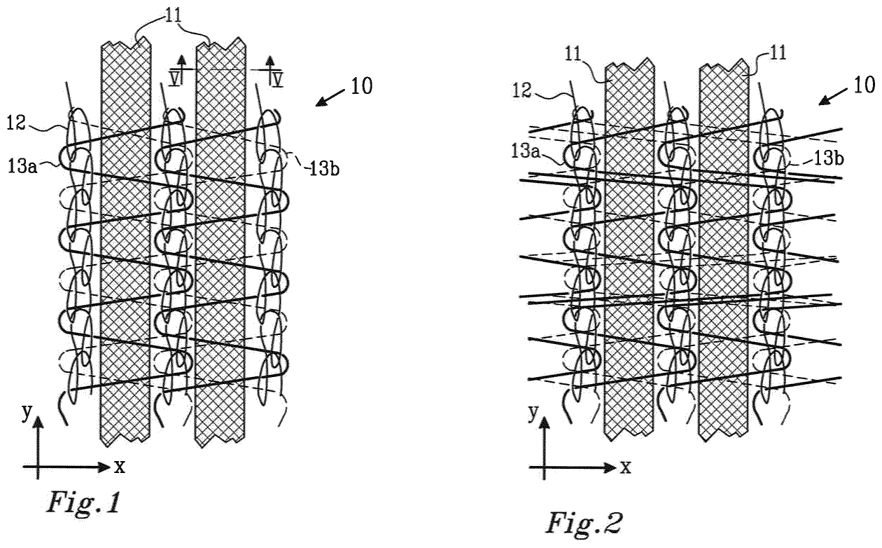

The present invention discloses a greenhouse screen comprising strips 11 of film material that are interconnected by a yarn system of longitudinal threads 12, 14, 18 and transverse threads 13a, 13b; 15; 19 by means of a knitting, warp-knitting or weaving process to form a continuous product as disclosed in FIGS. 1-4. The screen comprises a plurality of narrow strips of film material 11, 11′ held together by a yarn framework 12, 13a, 13b; 14, 15; 18, 19. The strips of film material 11, 11′ are preferably arranged closely edge to edge, so that they form a substantially continuous surface. The screen has a longitudinal direction, y, and a transverse direction, x, wherein the strips of film material 11 extend in the longitudinal direction. In some embodiments the strips of film material 11 may extend also in the transverse direction. A typical width of the strips is between about 2 mm and about 10 mm.

In FIG. 1 strips of film material 11 are interconnected by a warp knitting procedure as described in EP 0 109 951. The yarn framework comprises warp threads 12 forming loops or stitches and primarily extending in the longitudinal direction, y. The warp threads 12 are connected to one another by weft threads 13a and 13b extending across the film strips.

FIG. 1 shows an example of a mesh pattern for a fabric manufactured through a warp knitting process in which four guide bars are used, one for the strips of film material 11, two for the connecting weft threads 13a and 13b extending transversely to the film strips and one for the longitudinal warp threads 12.

The spaces between the strips of film material 11 have been strongly exaggerated in the figures to make the mesh pattern clear. Usually, the strips of film material 11 are located closely edge to edge. The longitudinal warp threads 12 are arranged on one side of the screen, the underside, while the transverse connecting weft threads 13a and 13b are located on both sides of the fabric, the upper and the underside. The term “transverse” in this respect is not restricted to a direction perpendicular to the longitudinal direction but means that the connecting weft threads 13a and 13b extends across the strips of film material 11 as illustrated in the drawings. The connection between the longitudinal warp threads 12 and the transverse weft threads 13a and 13b are preferably made on the underside of the fabric. The strips of film material 11 can in this way be arranged closely edge to edge without being restricted by the longitudinal warp threads 12.

The longitudinal warp threads 12 in FIG. 1 extend continuously in unbroken fashion along opposite edges of adjacent strips of film material 11, in a series of knitted stitches, in a so-called open pillar stitch formation.

The transverse weft threads 13a and 13b pass above and below the strips of film material 11 at the same location, i.e., opposed to each other, to fixedly trap the strips of film material. Each knitted stitch in the longitudinal warp threads 12 has two such transverse weft threads 13a and 13b engaging with it.

FIG. 2 shows another example of a mesh pattern for a fabric similar to the one shown in FIG. 1. The difference is that the transverse weft threads 13a and 13b pass over one and two strips of film material 11 in an alternating way.

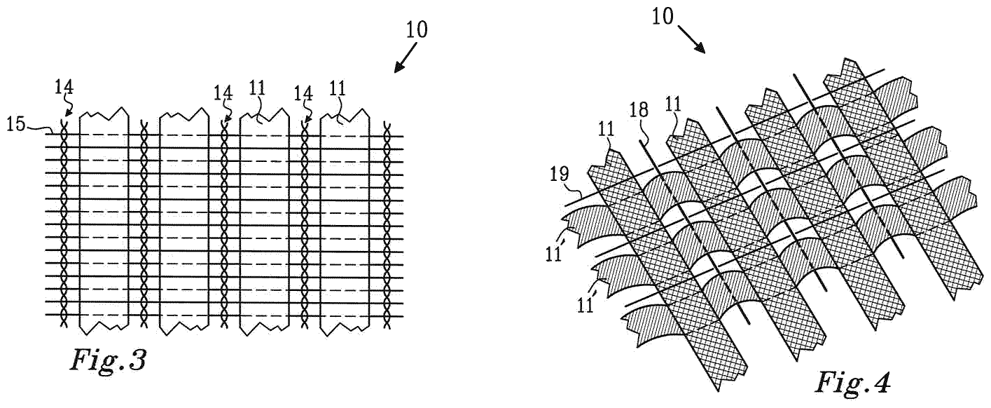

FIG. 3 shows a woven screen in which the strips of film material 11 are interconnected by warp threads 14 extending in longitudinal direction, y, and interwoven with weft threads 15 extending across the strips of film material 11 primarily in the transverse direction, x.

FIG. 4 shows another embodiment of a woven screen as described in U.S. Pat. No. 5,288,545 comprising strips of film material 11 (warp strips) extending in longitudinal direction, y, and strips of film material 11′ (weft strips) extending in transverse direction, x. The weft strips 11′ in the transverse direction may, as shown in FIG. 4, always be on the same side of the warp strips 11 in the longitudinal direction or may alternate on the upper and underside of the warp longitudinal strips 11. The warp and weft strips 11 and 11′ are held together by a yarn framework comprising longitudinal and transverse threads 18 and 19. The screen may comprise open areas that are free from strips to reduce heat build-up under the screen.

The films used in the greenhouse screens described herein are excellently suited as highly transparent convection barriers. Here, the film is usually cut into narrow strips with a width of from 2-10 mm, from which then together with polyester yarn (also this must be UV stabilized) a fabric or screen is produced, which is used as a cover inside the greenhouse. The greenhouse screens may contain strips of film as described herein in combination with strips of other films (especially with films with a light scattering effect or films that promote further increase in transparency). It is also possible to make a screen having “open” areas free from strips permitting ventilation through said screen

In order to provide the desired light transmitting properties, at least 50%, preferably at least 60%, more preferably at least 70%, more preferably at least 80%, more preferably at least 90% of the strips in the screen should be strips 11 of the coated single or multilayer film described herein. According to one embodiment all strips 11 in the screen are of the single or multilayer polyester film described and the strips 11 are arranged closely edge to edge, so that they form a substantially continuous surface. Alternatively, the film itself can be installed in the greenhouse. The film

[symbol]

The strips of film material used in the manufacture of the greenhouse screen described above comprise a single- or multilayer polyester film having a transparency of at least 92%, wherein the polyester film has a first and a second surface wherein a permanent antifog coating is applied to at least one of the first or second surfaces of the polyester film. The polyester film described herein comprises at least a base layer (B) which preferably contains at least 70 wt. % of thermoplastic polyester. Suitable for this are polyesters of ethylene glycol and terephthalic acid (=polyethylene terephthalate, PET), of ethylene glycol and naphthalene-2,6-dicarboxylic acid (=polyethylene-2,6-naphthalate, PEN), of 1, 4-bis-hydroxymethyl-cyclohexane and terephthalic acid [=poly(1,4-cyclohexane-dimethylene terephthalate), PCDT] as well as from ethylene glycol, naphthalene-2,6-dicarboxylic acid and biphenyl-4,4′-dicarboxylic acid (=polyethylene-2,6-naphthalate bibenzoate, PENBB). Particularly preferred are polyesters which consist of at least 90 mol %, preferably at least 95 mol %, of ethylene glycol and terephthalic acid units or of ethylene glycol and naphthalene-2,6′-dicarboxylic acid units. In a particularly preferred version of the polyester film, the base layer (B) is made of polyethylene terephthalate homopolymer.

The film material may comprise additional layer(s) (intermediate or cover layers) as explained further below. Cover layers are preferably also made of a polyester as described above, the composition being the same or different from the base layer described above.

The production of the polyester can be done e.g., by the transesterification process. This process starts from dicarboxylic acid esters and diols, which are reacted with the usual transesterification catalysts, such as zinc, calcium, lithium, magnesium, and manganese salts. The intermediate products are then polycondensed in the presence of commonly used polycondensation catalysts, such as antimony trioxide or titanium salts. They can also be produced by the direct esterification process in the presence of polycondensation catalysts. This process starts directly from the dicarboxylic acids and the diols.

Suitable aromatic dicarboxylic acids are benzene dicarboxylic acids, naphthalene dicarboxylic acids (e.g. naphthalene-1, 4- or 1,6-dicarboxylic acid), biphenyl-x,x′-dicarboxylic acids (especially biphenyl-4,4′-dicarboxylic acid), diphenylacetylene-x,x′-dicarboxylic acids (especially diphenylacetylene-4,4′-dicarboxylic acid) or stilbene-x,x′-dicarboxylic acids. Of the cycloaliphatic dicarboxylic acids, cyclohexanedicarboxylic acids (in particular cyclohexane-1,4-dicarboxylic acid) are advantageous. Of the aliphatic dicarboxylic acids, the (C₃-C₁₉) alkanedioic acids are particularly suitable, whereby the alk component can be straight-chain or branched. Of the heterocyclic dicarboxylic acids, 2,5-furan dicarboxylic acid are advantageous.

Suitable aliphatic diols for use in this process are, for example, diethylene glycol, triethylene glycol, aliphatic glycols of the general formula HO—(CH₂)n-OH, where n represents an integer from 3 to 6 (in particular propane-1,3-diol, butane-1,4-diol, pentane-1,5-diol and hexane-1,6-diol) or branched aliphatic glycols with up to 6 carbon atoms. Cycloaliphatic diols include cyclohexanediols (especially cyclohexane-1,4-diol). Suitable other aromatic diols correspond for example to the formula HO—C₆H₄—X—C₆H₄—OH, where X represents —CH₂—, —C(CH₃)₂—, —C(CF₃)₂—, —O—, —S— or —SO₂—. Bisphenols of the formula HO—C₆H₄—C₆H₄—OH are also well suited.

The polyester film advantageously contains particles to achieve a certain roughness of the surface and to enable improved winding of the film.

Usable particles are for example calcium carbonate, amorphous silica, talc, magnesium carbonate, barium carbonate, calcium sulphate, barium sulphate, lithium phosphate, calcium phosphate, magnesium phosphate, aluminum oxide, lithium fluoride, calcium, barium, zinc or manganese salts of the dicarboxylic acids used, titanium dioxide, kaolin or particulate polymers such as cross-linked polystyrene or acrylate particles. Preferably amorphous silica is used as particles. The particles are preferably used in a concentration of less than 0.5 wt. % based on the total weight of the film. Other particles which influence the surface and rheological properties of the film are preferably not present in the film.

If the film has a multilayer structure, the particles can be present in all layers, preferably in the cover layers.

The film must also have low transmission in the wavelength range from below 370 nm to 300 nm. For each wavelength in this specified range, the UV-light transmission is less than 40%, preferably less than 30% and especially preferably less than 15% (for measuring procedures, see measuring methods). This protects the film material of the screen from embrittlement and yellowing, but it also protects the plants and installations in the greenhouse from UV light. Between 390 and 400 nm, the transparency is greater than 20%, preferably greater than 30% and especially preferred greater than 40%, because this wavelength range is already clearly photosynthetically active and plant growth would be negatively affected if the filter was too strong in this wavelength range.

The low UV light transmission is achieved by adding an organic UV stabilizer. A low transmission of UV light also protects the flame stabilizer, which may also be present, from rapid destruction and severe yellowing. The organic UV stabilizer is selected from the group of triazines, benzotriazoles or benzoxazines. Triazines are particularly preferred, because they exhibit good thermal stability and low outgassing from the film at the processing temperatures of 275-310° C. customary for PET. Particularly suitable are 2-(4,6-diphenyl-1,3,5-triazin-2-yl)-5-(hexyl)oxy-phenol (e.g. Tinuvin® 1577, BASF) or 2-(2′-hydroxyphenyl)-4,6-bis(4-phenylphenylphenyl) triazine, (e.g. Tinuvin™ 1600, BASF). If these UV stabilizers are used, the preferred low transparency values below 370 nm can already be achieved at lower stabilizer concentrations, while at the same time achieving higher transparency at wavelengths above 390 nm.

The film, or in case of a multilayer film, all film layers contain at least one organic UV stabilizer. UV stabilizers are added to the cover layer(s) or to the monofilm in a preferred form in quantities from 0.3 to 3 wt. %, based on the weight of the respective layer. A UV stabilizer content of from 0.75 to 2.8 wt. % is particularly preferred. Ideally the cover layers should contain from 1.2 to 2.5 wt. % of UV stabilizer. In the multi-layer version of the film, the base layer, as well as the cover layers, preferably contains a UV stabilizer, whereby the UV stabilizer content in weight % in this base layer is preferably lower than in the cover layer(s). These stated contents in the cover layer(s) refer to triazine derivatives. If, instead of a triazine derivative, a UV stabilizer from the group of benzotriazoles or benzoxazinones is used either wholly or partially, the replaced portion of the triazine component must be substituted by 1.5 times the amount of a benzotriazole or benzoxazinone component.

The film may contain other stabilizers such as phosphorus compounds such as phosphoric acid and its derivatives such as phosphoric esters or phosphonic acid and its derivatives such as phosphonic esters, in order to provide a film with a reduced flammability.

The total thickness of the polyester film according to the invention can vary within certain limits. It amounts to from 10 to 40 μm, preferably from 14 to 23 μm, particularly preferably from 14.5 to 20 μm, whereby the base layer (B) of the multilayer variant preferably accounts for from 60 to 90% of the total thickness. The proportion of the base layer (B) in the three-layer version is preferably at least 60%, particularly preferably at least 70% and very particularly preferably at least 75% of the total film thickness.

In addition to self-regenerated material, polyester raw materials that have undergone a recycling process can also be used. Since recycled polyester raw materials can come from a variety of sources with different raw material qualities, it is important to only allow sources for which a certain degree of purity can be guaranteed. In this context, it was shown that so-called PCR material (Post-Consumer-Reclaim Material) which refers to raw materials that are obtained by recycling from old products that have already been used by a customer can be used to produce films surprisingly well, and which are also suitable as a basis for the film disclosed herein. The transparency of the film then undergoes a slight decrease, while the turbidity can increase slightly due to a low level of possible impurities. Surprisingly, the loss of transparency, which as described below, is critical to the performance of the greenhouse screen, is less than expected and is probably due to a levelling side effect of the permanent antifog coating.

The film may have a three-layer structure with a first cover layer (A) on one side of the base layer (B), and a second cover layer (C) on the opposite side of base layer (B). In this case the two cover layers (A) and (C) form the first and second cover layers (A) and (C). In some embodiments the first and second cover layers (A) and (C) can be the same. The polyester film may also have a two-layer structure wherein the base layer (B) is provided with only a first cover layer (A).

The antifog coating can be applied to the first cover layer (A) and/or to the second cover layer (C). A three-layer structure can be used to obtain a film with good transparency in which base layer (B) contains no particles other than those introduced by its own self-regenerated material. In this way, the proportion of recycled regrind can be increased, resulting in a particularly economical film production. Self-regenerated material is the term used to describe film remnants/waste that are produced during the film production process (e.g., hem strips). These can either be directly recycled during production or first collected and then added during the production of base layer (B).

The proportion of the recycled polyester material returned should be as high as possible without impairing the described film properties. In the film disclosed herein, the proportion of recycled polyester material in the base layer (B) can be 0-60 wt. %, preferably 0-50 wt. % and particularly preferably 0-40 wt. %, based on the total weight of the film.

The greenhouse screen comprising the film disclosed herein has a transparency of at least 92%, preferably 93%, particularly preferably 94% and ideally at least 94.5%. The higher the transparency, the better the plant growth is supported in the greenhouse.

The inventive transparency is achieved by the permanent antifog coating on at least one surface of the polyester film.

### Antifog Coating and Antireflection Modifications

In one version, the polyester film has an antifog coating applied on to one surface. With this design, the minimum transparency values are achieved. The antifog coating described below must have a lower refractive index than the polyester film. The refractive index of the antifog coating at a wavelength of 589 nm in the machine direction of the film is below 1.64, preferably below 1.60 and ideally below 1.58. Furthermore, the dry film thickness of the antifog coating must be at least 60 nm, preferably at least 70 nm and in particular at least 80 nm, and a maximum of 150 nm, preferably a maximum of 130 nm and ideally a maximum of 120 nm. This achieves an ideal increase in transparency in the desired wavelength range. Below a thickness of 60 nm, the antifog coating no longer contributes sufficiently to the increase in transparency. If the dry coating thickness of maximum 150 nm is exceeded, the additional application does not lead to a further increase in transparency. Furthermore, the higher coating consumption reduces the economic efficiency of the film.

In another embodiment, the antifog coating has a dry film thickness of at least 30 nm and preferably at least 40 nm and especially preferably at least 50 nm and is at most <60 nm. This achieves the permanent antifog effect that is in accordance with the invention. However, in order to achieve the transparency values of at least 92% as required by the invention, the polyester film must in this embodiment be provided with an anti-reflective modification on the side of the film opposite the antifog coating. The anti-reflective modification can be formed either by an antireflection coating or a top layer modification, both of which must have a lower refractive index than polyethylene terephthalate. If the antireflection modification is formed by an antireflection coating, this coating must have a lower refractive index than the polyester film. The refractive index of the antireflection coating at a wavelength of 589 nm in the machine direction of the film is below 1.64, preferably below 1.60 and ideally below 1.58. The antireflection coating can be coated onto any one of surfaces of the polyester film opposite the antifog coating, i.e., onto the surface of the base layer (B) in case of a single or two-layer film, or onto anyone of the top surface of the top layers (A) or (C) in case of a multilayer film.

Polyacrylates, silicones and polyurethanes, as well as polyvinyl acetate are particularly suitable. Suitable acrylates are described for example in EP-A-0 144 948 and suitable silicones for example in EP-A-0 769 540. Coatings based on polyacrylates, and polyurethanes are particularly preferred, as they do not tend to exudate coating components or peel off in the greenhouse, which is far more likely to happen with silicone-based coatings.

Preferably, the antireflection coating contains less than 10% by weight, more preferably less than 5% by weight and most preferably less than 1% by weight of repeating units containing an aromatic structural element. Above 10% by weight of repeating units containing an aromatic structural element, there is a significant deterioration in the weathering stability of the coating. The antireflection coating contains at least 1 wt. % (dry weight) of a UV stabilizer, preferably Tinuvin 479 or Tinuvin 5333-DW. Less preferred are HALS (hindered amine light stabilizers) since these lead to a marked yellowing of the material during regeneration (recycling of film residues from production) and thus to a reduction in transparency.

The thickness of the antireflection coating is at least 60 nm, preferably at least 70 nm and in particular at least 80 nm and is a maximum of 130 nm, preferably a maximum of 115 nm and ideally a maximum of 110 nm. This achieves an ideal increase in transparency in the desired wavelength range. In a preferred design, the thickness of the coating is more than 87 nm, and particularly preferred more than 95 nm. In this preferred design, the thickness of the antireflection coating is preferably less than 115 nm and ideally less than 110 nm. In this narrow thickness range, the increase in transparency is close to the optimum and at the same time the reflection of the UV and blue range of light is increased in this thickness range compared to the rest of the visible spectrum. This saves on UV stabilizer on the one hand, but above all leads to a shift in the blue/red ratio in favor of the red component. This results in improved plant growth and increased flower and fruit set. Suitable antireflection coatings are described in Examples 1-3 of EP3251841B1.

If the antireflection modification is formed by a top layer modification, the top layer modification is formed by co-extrusion onto the base layer (B) and is located on the side of the film opposite the antifog coating. Note that the top layer modification is never co-extruded onto the cover layers (A) or (C). This top layer modification must consist of a polyester which has a lower refractive index than the polyester of base layer (B). The refractive index at a wavelength of 589 nm in the machine direction of the top layer applied by co-extrusion is below 1.70, preferably below 1.65 and particularly preferably below 1.60. This refractive index is achieved by the polymer containing a co-monomer content of at least 2 mol %, preferably at least 3 mol % and ideally at least 6 mol %. These values for the refractive index cannot be achieved with a co-monomer content below 2 mol-%. The co-monomer content is below 20 mol-%, particularly preferred below 18 mol-% and particularly preferred below 16 mol-%. Above 16 mol % the UV stability deteriorates significantly due to the amorphous nature of the layer, and above 20 mol % the same level of UV stability as below 16 mol % cannot be achieved even with a further addition of UV stabilizer.

Co-monomers are all monomers except ethylene glycol and terephthalic acid (or dimethyl terephthalate). Preferably, no more than two co-monomers are used simultaneously. Isophthalic acid is particularly preferred as co-monomer. A layer with a co-monomer content of more than 8 mol % (based on the polyester in this layer, or its dicarboxylic acid component) also preferably contains at least 1.5 wt. %, and especially preferably more than 2.1 wt. % of an organic UV stabilizer, based on the total weight of the layer, to compensate for the poorer UV stability of layers with increased co-monomer content.

In another particularly preferred design, both polyester film surfaces are provided with an antifog coating with a thickness of at least 60 nm, preferably at least 70 nm and in particular at least 80 nm and maximum 150 nm, preferably maximum 130 nm and ideally maximum 120 nm. The refractive indices of both antifog coatings are below 1.64 at a wavelength of 589 nm in the machine direction of the film, preferably below 1.60 and ideally below 1.58. The preferred transparency values of at least 94.5% can be achieved by providing the antifog coating on both surfaces of the polyester film. Due to the use of a single coating composition, highly transparent films with very good permanent antifog properties (cold fog and hot fog test) can be produced particularly economically in this way. This film is particularly suitable for use in greenhouses with continuously high humidity (condensation), as double-sided antifog coatings prevent the formation of water droplets on both sides of the film surface and efficiently prevents the resulting light scattering.

In order to achieve the permanent anti-fogging effect in accordance with the invention, the film must be provided with a permanent anti-fog coating on at least one side. The permanent anti-fogging properties of the surface are achieved if the formation of fine water droplets (e.g., condensation in a greenhouse) on the surface of the polyester film is not observed and at the same time the wash-off resistance of the coating is good. A minimum requirement for good anti-fogging properties is a high surface energy or a low contact angle α (see method section). The anti-fogging properties are sufficiently good if the surface tension of the anti-fogging surface is at least 45 mN/m, preferably at least 55 mN/m and especially preferably at least 60 mN/m. A permanent antifog effect can be achieved for a period of at least one year in the cold fog test and for at least three months in the hot fog test (desired ratings A and B; see Methods section or example table). By using the coating composition described below, the permanent anti-fogging properties and a transparency of at least 92%, are achieved.

The antifog coating is formed by drying an antifog coating composition as described herein. In the case of a multi-layer design with an anti-reflection-modified co-extruded layer, the permanent antifog coating is applied to the side of the film opposite the anti-reflection-modified co-extruded layer.

The antifog coating composition according to the invention (also referred to coating solution and coating dispersion herein) is an aqueous solution comprising a) a polyvinyl alcohol (PVOH), or a hydrophilic PVOH copolymer, b) an inorganic hydrophilic material, and c) a crosslinker.

Common antifog coatings contain surfactants to achieve permanent antifog properties. However, the use of surfactants is disadvantageous, especially in the case of inline production. Surprisingly, it was found that the use of polyvinyl alcohols or hydrophilic amorphous copolymers in the antifog coating leads to good permanent antifog properties and that the use of surfactants in this antifog coating can be dispensed with.

Component a) is a polyvinyl alcohol copolymer, or a hydrophilic amorphous copolymer.

When using polyvinyl alcohol copolymers, it is advantageous to have a medium to high degree of saponification of 60-95%, preferably 70-90%, such as Gohsenol KP08R (degree of saponification 71-73.5%) to ensure solubility in water without the raw material being washed off too quickly. Lower saponified copolymers are also possible if instead of the acetate group, a group simplifying the solubility in water is included. In this case a part of the acetate groups in the polyvinyl alcohol is replaced by polyethylene glycol. An example of such a polyvinyl alcohol copolymer is GohsenX-LW200, which is highly soluble in water despite a degree of saponification of only 46-53%.

The polyvinyl alcohol copolymer according to the present invention is an alkanediol-polyvinyl alcohol copolymer. The alkanediol-polyvinyl alcohol copolymer is preferably selected from the group consisting of propanediol-polyvinyl alcohol copolymer, butanediol-polyvinyl alcohol copolymer, pentanediol-polyvinyl alcohol copolymer or mixtures thereof. The polyvinyl alcohol copolymer butanediol-polyvinyl alcohol copolymer is particularly preferred.

This particularly preferred class of polyvinyl alcohol copolymers are marketed under the trade name Nichigo G-Polymer and represent butanediol-vinyl alcohol copolymers which are highly water soluble at saponification levels of 86-99%, show a low foaming tendency in aqueous media and are well wetted by water droplets as part of a coating on PET, e.g., the G-Polymer OKS8089.

In general, polyethylene glycol or cellulose ether would also be conceivable, but these substance classes are often difficult to coat onto the film in the so-called inline process or have negative effects on the regenerability/recyclability of the film. Polyethylene glycols have a decomposition temperature which is in the range of the production temperatures of polyester film, so that an undamaged production is not possible. If the films are provided with an antifog coating containing cellulose ethers, this leads to poor regenerability of the film, since the temperatures of over 250° C. occurring during regeneration lead to decomposition of the cellulose ethers, which results in a clearly perceptible yellow coloration of the resulting regenerate. Regenerate produced in this way can no longer be used to manufacture films whose optical properties represent a key qualification.

Component a) is used in a concentration of from 2 to 10 wt. % and preferably from 4 to 8 wt. % based on the total solids content of the coating solution. It is characterized by excellent film-forming properties, especially in an inline process.

As component b) inorganic and/or organic particles, such as fumed silica, inorganic alkoxides containing silicon, aluminum or titanium (as described in DE 698 33 711), kaolin, cross-linked polystyrene or acrylate particles can be used. Preferably, porous SiO₂, such as amorphous silica, as well as pyrogenic metal oxides, or aluminum silicates (zeolites) are used. These are used in a concentration of from 1 to 6 wt. % (regarding the coating dispersion), preferably from 2 to 4 wt. % (regarding the coating dispersion). In addition, SiO₂ nanoparticles can be used additionally or exclusively to further increase the wettability of the film surface and to absorb enough water to form a homogeneous water film and thus create the anti-fogging impression. Hydrophilic fumed silicas such as e.g., Aerodisp W7622 (Evonik Resource Efficiency GmbH) which contains 22 wt. % of SiO₂ particles with a mean aggregate size of 0.10 μm are particularly suitable.

Furthermore, the coating dispersion contain a component c) in a concentration of from 2 to wt. % (with respect to the coating dispersion), preferably from 4 to 8 wt. % (with respect to the coating dispersion). The coating dispersion is preferably an oxazoline modified polymer (oxazoline based crosslinker), which is available e.g., under the trade name EPOCROS WS-500 and especially EPOCROS WS-700 from Nippon Shokubai. By using the crosslinker in the mentioned quantities the abrasion resistance of the coating is improved. Other crosslinkers such as e.g., melamine is a chemical compound containing a high amount of nitrogen atoms which tends to give the film a yellow colour when regenerating. Thus, melamines are not suitable for use in antifog coatings applied to a film material to be used in a greenhouse screen.

Surfactants can optionally be added to the dispersion to improve the antifog effect. However, this is bought at the expense of the disadvantage that the permanent antifog coating can no longer be applied to the films very well in an inline process. It is assumed that the surfactants, in contrast to the other polymer components of the coating dispersion, can evaporate already during film production and are therefore no longer available for the intended purpose. In the offline process this circumstance can be counteracted by preselecting more gentle drying conditions. The disadvantage of an offline process, however, is the additional expenditure in the form of at least one further processing step, so that additional surfactants should be avoided if possible. Possible surfactants for further addition include polyalkylene glycol ether, polysorbate 80 (polyoxyethylene(20)sorbitan monooleate), sulphosuccinic acid esters, alkyl sulphates, alkylbenzene sulphates. Possible additions are up to 7 wt. % in the coating dispersion, but preferably <0.2 wt. %, and ideally 0 wt. %.

Furthermore, the coating solution can contain one or more defoamers. The use of defoamers has proven to be particularly beneficial for highly concentrated dispersions, as here the foam formation at the applicator can be reduced, thus ensuring a stable production process. However, it must be accepted that the addition of defoamers, or even further amphoteric or surfactant additives, can potentially lead to coating inhomogeneities on the film surface. The use of such additives must therefore be carefully weighed, and the dosage should be kept rather low.

Above the limits set by the invention, the economic efficiency of the film is reduced due to the use of a surplus of coating components. Below the limits according to the invention, the desired anti-fogging properties occur only to a limited extent (not permanently) because the desired coating thickness is too low. By adhering to the limits of the invention, the reaction product of the coating dispersion, especially on a biaxially stretched polyester film, provides a good anti-fogging effect, high wash-off resistance, and high hydrophilicity.

### Method of Production

The manufacturing process for polyester films is described e.g., in the “Handbook of Thermoplastic Polyesters, Ed. S. Fakirov, Wiley-VCH, 2002” or in the chapter “Polyesters, Films” in the “Encyclopedia of Polymer Science and Engineering, Vol. 12, John Wiley & Sons, 1988”. The preferred process for producing the film includes the following steps. The raw materials are melted in one extruder per layer and extruded through a single- or multi-layer slit die onto a cooled take-off roll. This film is then reheated and stretched (“oriented”) in longitudinal (MD or machine direction) and transverse direction (TD or transverse direction) or in transverse and longitudinal direction. The film temperatures in the stretching process are generally 10 to 60° C. above the glass transition temperature Tg of the polyester used, the stretching ratio of the longitudinal stretching is usually 2.5 to 5.0, especially 3.0 to 4.5, that of the transverse stretching 3.0 to 5.0, especially 3.5 to 4.5. The longitudinal stretching can also be carried out simultaneously with the transverse stretching (simultaneous stretching) or in any conceivable sequence. The film is then thermoset at oven temperatures of 180 to 240° C., in particular at 210 to 230° C. The film is then cooled and rewound.

The biaxially oriented polyester film as described herein is preferably coated in-line, i.e., the coating is applied during the film manufacturing process before longitudinal and/or transverse stretching. In order to achieve good wetting of the polyester film with the aqueous coating composition, the surface is preferably first corona treated. The antifog coating can be applied using a common suitable method such as a slot caster or a spray process. Especially preferred is the application of the coating by means of the “reverse gravure-roll coating” process, in which the coating can be applied extremely homogeneously with application weights (wet) between 1.0 and 3.0 g/m 2. Also preferred is the application by the Meyer-Rod process, with which greater coating thicknesses can be achieved. The coating on the finished film preferably has a thickness of at least 60 nm, preferably at least 70 nm and especially at least 80 nm. The in-line process is economically more attractive in this case, because with a coating on both sides, the antifog and antireflection coatings can be applied simultaneously, so that one process step (see below: off-line process) can be saved.

In an alternative process, the coatings described above are applied by off-line technology. During the off-line application process, the antireflection and/or anti-fog coating is applied to the corresponding surface of the polyester film by means of off-line technology in an additional process step following the film production, using an engraved roller (forward gravure). The maximum limits are determined by the process conditions and the viscosity of the coating dispersion and find their upper limit in the processability of the coating dispersion. The antifog coating and the antireflection coating may be applied onto the surfaces of a multilayer film, i.e., a film containing base layer (B) and two cover layers (A) and (C), on the surfaces of a two-layer film, i.e., a film containing base layer (B) and one cover layer (A), or onto a single-layer film, i.e., a film containing only base layer (B). While it is in principle possible to apply both the antifog and the antireflection coating on the same surface side of the polyester film, it has proved unfavourable to apply the antifog coating to an undercoating (antifog coating to an antireflection coating), since on the one hand the material consumption increases and on the other hand an additional process step is required, which reduces the economic efficiency of the film.

With some in-line coating processes, the particularly preferred coating thicknesses cannot be achieved due to the high viscosity of the coating dispersion. In this case, it is advisable to choose the off-line coating process, as here dispersions with lower solid contents and higher wet applications can be processed, resulting in easier processability. In addition, higher coating thicknesses can be achieved with off-line coatings, which have proven to be advantageous for applications that have high demands on the lifetime of the anti-fogging effect. For example, coating thicknesses of 80 nm can be achieved particularly easily with the off-line process, which allows a better permanent anti-fogging effect to be achieved, but with no further increase in transparency.

### Description of Test Methods

The following measuring methods were used to characterize the raw materials and the films within the scope of the present invention:

### UV/Vis Spectra, Transmission at Wavelength x

The light transmission of the films at different wavelengths were measured in a UV/Vis two-beam spectrometer (Lambda 950S) from Perkin Elmer USA. A film sample measuring approximately 3×5 cm is inserted into the beam path perpendicular to the measuring beam via a flat sample holder. The measuring beam passes through an integrating sphere to the detector, where the intensity is determined to determine the transparency at the desired wavelength. The background is air. The transmission is read at the desired wavelength.

### Haze, Transparency

The test is used to determine the haze and transparency of plastic films where the optical clarity or haze is essential for the utility value. The measurement is carried out on the Hazegard Hazemeter XL-21 1 from BYK Gardner according to ASTM D 1003-61.

### Determination of the Refractive Index as a Function of the Wavelength

To determine the refractive index of a film substrate and an applied coating as a function of wavelength, spectroscopic ellipsometry is used.

The analyses were performed according to the following reference:

J. A. Woollam et al: Overview of variable-angle spectroscopic ellipsometry (VASE): I. Basic theory and typical applications. In: Optical Metrology, Proc. SPIE, Vol. CR 72 (Ghanim A. A.-J., Ed.); SPIE—The International Society of Optical Engineering, Bellingham, WA, USA (1999), p. 3-28.

First, the base film without coating or modified coex side was analyzed. To suppress the backside reflection, the backside of the foil was roughened with a sandpaper with the finest possible grain size (e.g. P1000). The film was then measured with a spectroscopic ellipsometer, here an M-2000 from J. A. Woollam Co, Inc, Lincoln, NE, USA, equipped with a rotating compensator. The machine direction of the sample was parallel to the light beam. The measured wavelength was in the range of 370 to 1000 nm, the measuring angles were 70 and 75°.

The ellipsometric data ψ and Δ were then simulated with a model.

In this case the Cauchy model

$$n ( λ ) = A + \frac{B}{{λ}^{2}} + \frac{C}{{λ}^{4}}$$

(wavelength in λ in μm) is appropriate.

The parameters A, B and C are varied so that the data correspond as closely as possible to the measured spectrum ψ (amplitude ratio) and Δ (phase ratio). To check the quality of the model, the mean Squared Error (MSE) value can be included, which should be as small as possible and compares the model with measured data (ψ)(λ) and Δ(λ)).

$$M S E = \sqrt{\frac{1}{3 a - m} {\sum }_{i = 1}^{a} [ {( {N}_{E , i} - {N}_{G , i} )}^{2} + {( {C}_{E , i} - {C}_{G , i} )}^{2} + {( {S}_{E , i} - {S}_{G , i} )}^{2} ]} \cdot 1000$$

a=number of wavelengths, m=number of fit parameters, N=cos(2ψ)), C=sin(2ψ)) cos(Δ), S=sin(2ψ)) sin(Δ)).

The obtained Cauchy parameters A, B and C for the base film allow the calculation of the refractive index n as a function of the wavelength, valid in the measured range 370 to 1000 nm.

The coating or a modified co-extruded layer can be analysed in a similar way. To determine refractive index of the coating and/or the coextruded layer, the back of the film must also be roughened as described above. Here, the Cauchy model can also be used to describe the refractive index as a function of wavelength. However, the respective layer is now located on the already known substrate. Since the parameters of the film base are now already known, they should be kept constant during modelling, which is taken into account in the respective evaluation software (CompleteEASE or WVase). The thickness of the layer influences the obtained spectrum and has to be considered during modelling.

### Surface Free Energy

The surface free energy was determined according to DIN 55660-1.2. Water, 1,5-pentanediol and diiodomethane serve as test liquids. The determination of the static contact angle between the coated film surface and the tangent of the surface contour of a horizontally lying liquid drop was carried out using the measuring device DSA-100 of the company Krüss GmbH, Hamburg, Germany. The determination was carried out at 23° C.±1° C. and 50% relative humidity on discharged film samples that had been conditioned in standard climate at least 16 hours before. The evaluation of the surface free energy as (total) according to the method of Owens-Wendt-Rabel-Kaelble (OWRK) was carried out by means of the software Advance Ver. 4 belonging to the device with the following parameters of surface tension for the three standard liquids as seen In Table 1:

TABLE 1
Parameters of surface tension for three standard liquids.

| | Surface free energy [mN/m] | | |
|---|---|---|---|
| | σ_{L} | σ_{L, D} | σ_{L, P} |
| Liquids | (total) | (dispers) | (polar) |
| Distilled water | 72.8 | 21.8 | 51.0 |
| 1,5-Pentandiol | 43.3 | 27.6 | 15.7 |
| Di-iodomethane | 50.8 | 49.5 | 1.3 |

### Determination of the Antifog Effect

Cold fog test: The anti-fogging properties of polyester films are determined as follows: In a laboratory tempered to 23° C. and 50% relative humidity, film samples are sealed onto a menu tray (length approx. 17 cm, width approx. 12 cm, height approx. 3 cm) made of amorphous polyethylene terephthalate (=APET) containing approx. 50 ml water. The trays are stored in a refrigerator at a temperature of 4° C., placed at an angle of 30° and removed for evaluation after 12 h, 24 h, 1 week, 1 month, 1 year. The formation of condensation when the 23° C. warm air is cooled to refrigerator temperature is checked. A film provided with an effective anti-fogging agent is transparent even after condensation has formed, as the condensate forms a coherent, transparent film. Without an effective anti-fogging agent, the formation of a fine mist of droplets on the film surface leads to reduced transparency of the film; in the worst case, the contents of the menu tray are no longer visible.

Another test method is the so-called hot steam or hot fog test. A QCT condensation tester from Q-Lab is used for this. This simulates the anti-fogging effects of climatic humidity influences by condensing warm water directly on the film. In a few days or weeks, results can be reproduced that are caused by moisture within months or years. For this purpose, the water is tempered to 60° C. in the QCT condensation unit and the film is clamped in the corresponding holder. The covered film has an angle of inclination of approx. 30°. The assessment is the same as described above. With this test, the long-term anti-fogging effect or the wash-off resistance of the film can be tested, as the steam constantly condenses on the film and runs off and/or drips off again. Easily soluble substances are thus washed off and the anti-fogging effect diminishes. This test is also carried out in a laboratory with a temperature of 23° C. and 50% relative humidity.

The antifog effect (antifog test) is assessed visually.

### Rating:

A transparent film that shows no visible water i.e., it is completely transparent: excellent antifog effect.
B Some random, irregularly distributed water drops on the surface, discontinuous water film: acceptable antifog effect.
C A complete layer of large transparent water drops, poor visibility, lens formation, drop formation: poor antifog effect.
D An opaque or transparent layer of large water droplets, no transparency, poor light transmission: very poor antifog effect.

### Standard Viscosity (SV-Value)

The standard viscosity in diluted solution SV was measured in an Ubbelohde viscometer at (25±0.05) ° C., following DIN 53 728 Part 3. Dichloroacetic acid (DCE) was used as solvent. The concentration of dissolved polymer was 1 g polymer/100 ml pure solvent. The polymer was dissolved for 1 hour at 60° C. If the samples were not completely dissolved after this time, up to two dissolution tests were performed at 80° C. for 40 min each and the solutions were then centrifuged for 1 hour at a speed of 4100 min⁻¹.

From the relative viscosity (ηᵣₑₗ=ηₛ) the dimensionless SV value is determined as follows:

SV=(ηᵣₑₗ−1)×1000

The proportion of particles in the film or polymer raw material was determined by ash determination and corrected by appropriate additional weighing. I.e.:

Weighing=(weighing corresponding to 100% polymer)/[(100−particle content in weight %)/100)].

### EXAMPLES

The following base materials were used to produce the films described below:
PET1=Polyethylene terephthalate from ethylene glycol and terephthalic acid with an SV value of 820 and a DEG content of 0.9% by weight (diethylene glycol content as monomer).
PET2=PCR raw material, produced from PET flakes obtained from so-called “PET post-consumer articles” (mainly bottles and trays made of PET) available e.g., under the trade name MOPET (R), Morssinkhof. Due to the condensation process, the SV value is higher than that of conventional PET, and often amounts to values above 950, DEG content approx. 1.5% by weight.
PET3=Polyethylene terephthalate consisting of ethylene glycol and dimethyl terephthalate with an SV value of 820 and a DEG content of 0.9 wt. % (diethylene glycol content as monomer) and 1.5 wt. % of silicon dioxide pigment Sylobloc 46 with a d 50 of 2.5 μm. Produced by the PTA process. Catalyst potassium titanyl oxalate with 18 ppm titanium. Transesterification catalyst zinc acetate.
PET4=Polyethylene terephthalate with an SV value of 700 containing 20% by weight of Tinuvin 1577 The UV stabilizer has the following composition 2-(4,6-diphenyl-1,3,5-triazin-2-yl)-5-(hexyl)oxy-phenol (Tinuvin® 1577 of BASF, Ludwigshafen, Germany). Tinuvin 1577 has a melting point of 149° C. and is thermally stable at 330° C.
PET5=Polyethylene terephthalate with an SV value of 710, containing 25 mol % isophthalic acid as co-monomer.

The above raw materials were melted in one extruder per layer and extruded through a three-layer slit die (A−B−A/C layer sequence) onto a cooled take-off roll. The amorphous pre-film obtained in this way was then first stretched lengthwise. The stretched film was corona treated in a corona discharger and then coated with the solution described above by reverse engraving. An engraved roller with a volume of 6.6 cm³/m² was used. The film was then dried at a temperature of 100° C. and then cross-stretched, thermo-set and rolled up. The conditions in the individual process steps were:

| | | |
|---|---|---|
| Longitudinal stretching: | Temperature: | 80-115° C. |
| | Longitudinal stretching | 3.8 |
| | ratio: | |
| Transverse stretching: | Temperature: | 80-135° C. |
| | Transverse stretching ratio: | 3.9 |
| Annealing: | | 2 sec at 225° C. |

### Example 1

Surface layers (A) and (C): combination of
10 wt. % PET4
7.2 wt. % PET3
82.8 wt. % PET1

Base layer (B): combination of
90 wt. % PET1
10 wt. % PET4

Coating applied only on top layer C (one side coated):

### Coating 1:

The following composition of the antifog coating solution was used
84.3 wt. % deionised water
5.82 wt. % G-Polymer OKS 8089 (MCPP Europe GmbH)
6.05 wt. % Epocros WS700 (Nippon Shokubai Co., Ltd.)
3.83 wt. % Aerodisp W7622 (Evonik Resource Efficiency GmbH)

The different components were slowly added to deionized water while stirring and stirred for at least 30 minutes before use. The solid content was 15 wt. %. The thickness of the dry coating was 80 nm.

Unless otherwise described, the coating is applied in an in-line process. The properties of the film thus obtained are shown in Table 2.

### Example 2

In comparison to example 1, a second top layer (A) was also coated with Coating 1 as in Example 1. Coating on the top layer (C): as in example 1

The individual components were slowly added to deionized water while stirring and stirred for at least 30 minutes before use.

The solids content was 15 wt. %. The thickness of the dry coating was 80 nm.

### Example 3

In comparison to example 1, the base layer (B) was produced using PCR raw material, i.e. 90% PET2+10% PET4. In the resulting film, traces of the smallest contaminants, which originate from the PCR raw material, were visible.

### Examples 4 and 5

The remaining examples are based on the production procedure in analogy of inventive example 1. The formulas of the base film and for the coating are described in Table 2 below:

### Comparative Example 1

### Coating 2:

Coating as in EP 1 777 251 A1, consisting of a hydrophilic coating in which the drying product of the coating composition contains water, a sulfopolyester, a surfactant and optionally an adhesion-promoting polymer. This film has a hydrophilic surface that prevents the film from fogging with water droplets for a short time. The following coating solution composition was used:
1.0 wt. % of sulfopolyester (copolyester of 90 mol % isophthalic acid and 10 mol % sodium sulfoisophthalic acid and ethylene glycol)
1.0 wt. % of an acrylate copolymer consisting of 60% by weight methyl methacrylate, 35 wt. % ethyl acrylate and 5 wt. % N-methylolacrylamide
1.5 wt. % of diethylhexylsulfosuccinate sodium salt (Lutensit A-BO BASF AG).

TABLE 2
Properties of the films of the examples

| | | | | | | | Comparative |
|---|---|---|---|---|---|---|---|
| | | Example 1 | Example 2 | Example 3 | Example 4 | Example 5 | example 1 |
| Layer | Film | 19 | 19 | 19 | 19 | 19 | 19 |
| | thickness | | | | | | |
| | (μm) | | | | | | |
| | Layer A | 1 | 1 | 1 | 1 | 1 | 1 |
| | Layer B | 17 | 17 | 17 | 17 | 17 | 17 |
| | Layer C | 1 | 1 | 1 | 1 | 1 | 1 |
| Coating on side A | | | Dry thickness | Dry thickness | Dry thickness: | | |
| | | | 80 nm. Antifog- | 80 nm. Antifog- | 75 nm. Acrylate | | |
| | | | Coating: 1 | Coating: 1 | coating and method | | |
| | | | | | as described in Exp. | | |
| | | | | | 1 in EP 0144948 | | |
| Coating on side C | | Dry thickness | Dry thickness | Dry thickness | Dry thickness | Dry thickness | Dry thickness |
| | | 80 nm. Antifog- | 80 nm. Antifog- | 80 nm. Antifog- | 80 nm. Antifog- | 80 nm. Antifog- | 40 nm. Antifog- |
| | | Coating: 1 | Coating: 1 | Coating: 1 | Coating: 1 | Coating: 1 | Coating: 2 |
| A-Layer | PET 1 | 82.8 | 82.8 | 82.8 | 82.8 | 32.8 | 82.8 |
| | PET 2 | | | | | | |
| | PET 3 | 7.2 | 7.2 | 7.2 | 7.2 | 7.2 | 7.2 |
| | PET 4 | 10.0 | 10.0 | 10.0 | 10.0 | 10.0 | 10.0 |
| | PET 5 | 0 | 0 | 0 | 0 | 50 | 0 |
| B-Layer | PET 1 | 90 | 90 | 60 | 90 | 90 | 90 |
| | PET 2 | | | 30 | | | |
| | PET 4 | 10 | 10 | 10 | 10 | 10 | 10 |
| C-Layer | PET 1 | 82.8 | 82.8 | 82.8 | 82.8 | 82.8 | 82.8 |
| | PET 2 | | | | | | |
| | PET 3 | 7.2 | 7.2 | 7.2 | 7.2 | 7.2 | 7.2 |
| | PET 4 | 10.0 | 10.0 | 10.0 | 10.0 | 10.0 | 10.0 |
| Transparency | in % | 92 | 94.8 | 94.9 | 94.2 | 93.7 | 91.2 |
| Haze | | 8.3 | 20.2 | 21.7 | 14.3 | 10.6 | 10.0 |
| UV-Stability | in % | 70 | 70 | 63 | 72 | 65 | 68 |
| UTS | | | | | | | |
| Free surface | [mN/m] | 58 | 58 | 61 | 58 | 59 | 49 |
| energy σₛ | | | | | | | |
| (total) (side C) | | | | | | | |
| Cold-Fog Test | | A | A | A | A | A | C |
| Hot-Fog Test | | A | A | A | A | A | D |

1. A greenhouse screen comprising strips of film material that are interconnected by a yarn system of longitudinal threads and transverse threads by means of a knitting, warp-knitting or weaving process to form a continuous product, wherein at least 50% of the strips comprise a single- or multilayer polyester film having a transparency of at least 92%, wherein the polyester film has a first and a second surface wherein a permanent antifog coating has been applied to at least one of the first or second surfaces of the polyester film, the antifog coating comprises
a) at least one water-soluble polymer;
b) an inorganic, hydrophilic material and
c) a crosslinker,
wherein the water-soluble polymer is a polyvinyl alcohol copolymer.

2. The greenhouse screen according to claim 1, said polyester film comprising a base layer and a first cover layer, or a first cover layer and a second cover layer, wherein the first cover layer is applied onto a first or second side of the base layer and, if present, the second cover layer is applied to the side of the base layer opposite the first cover layer.

3. The greenhouse screen according to claim 1, wherein the thickness of the polyester film is at least 10 μm and at most 40 μm, preferably at least 14 μm and at most 23 μm, particularly preferably at least 14.5 μm and at most 20 μm.

4. The greenhouse screen according to claim 2, wherein the base layer is at least 70% by weight. % of a thermoplastic polyester based on the total weight of the base layer, wherein the thermoplastic polyester consists of at least 90 mol %, preferably at least 95 mol % of units derived from ethylene glycol and terephthalic acid, or units derived from ethylene glycol and naphthalene-2,6-dicarboxylic acid.

5. The greenhouse screen according to claim 1, wherein the polyester film contains particles selected from the group consisting of calcium carbonate, amorphous silica, talc, magnesium carbonate, barium carbonate, calcium sulfate, barium sulfate, lithium phosphate, calcium phosphate, magnesium phosphate, aluminum oxide, lithium fluoride, calcium, barium, zinc or manganese salts of the dicarboxylic acids used, titanium dioxide, kaolin or particulate polymers of the group consisting of crosslinked polystyrene and arcrylate particles.

6. The greenhouse screen according to claim 2, wherein the base layer, and if present, the first and second cover layers and comprise a UV stabilizer.

7. The greenhouse screen according to claim 6, wherein the UV stabilizer is selected from the group consisting of triazines, benzotriazoles and, benzoxazinones, wherein triazines are preferred, wherein the base layer, the first cover layer and, if present, the second cover layer comprise the UV stabilizer in an amount of from 0.3 to 3 wt. %, preferably from 0.75 to 2.8 wt. %, based on the weight of the respective layer.

8. The greenhouse screen according to claim 1, wherein the antifog coating has a lower refractive index than the polyester film.

9. The greenhouse screen according to claim 1, wherein the polyvinyl alcohol of the copolymer antifog coating is an alkanediol-polyvinyl alcohol copolymer selected from the group consisting of propanediol-polyvinyl alcohol copolymer, butanediol-polyvinyl alcohol copolymer, pentanediol-polyvinyl alcohol copolymer or mixtures thereof.

10. The greenhouse screen according to claim 1, wherein the inorganic, hydrophilic material is chosen from the group consisting of fumed silica, inorganic alkoxides containing silicon, aluminum or titanium, kaolin, cross-linked polystyrene, acrylate particles, porous SiO₂, amorphous silica, pyrogenic metal oxides, aluminum silicates, SiO₂ nanoparticles and hydrophilic fumed silicas.

11. The greenhouse screen according to claim 1, wherein the crosslinker is an oxazoline based crosslinker.

12. The greenhouse screen according to claim 1, wherein the antifog coating has a thickness of at least 60 nm and at most 150 nm, preferably at least 70 nm and at most 130 nm, particularly preferably of at least 80 nm and at most 120 nm.

13. The greenhouse screen according to claim 1, wherein the antifog coating has been applied to the first or the second surfaces of the polyester film and the surface of the polyester film opposite the antifog coating has an antireflective modification which
a) is an antireflection coating, or
b) is a top layer modification.

14. The greenhouse screen according to claim 13, wherein the top layer modification has been formed by co-extrusion on the base layer and comprises a polyester having a lower refractive index than the polyester of the base layer.

15. The greenhouse screen according to claim 13, wherein the antifog coating has a thickness of at least 30 nm, preferably at least nm, particularly preferably at least 50 nm and at most 150 nm when it is located opposite the antireflective modification.

16. The greenhouse screen according to claim 1, wherein at least 60%, more preferably at least 70%, more preferably at least 80%, more preferably at least 90% of the strips in the screen should be strips of the coated single or multilayer polyester film.

17. (canceled)

18. (canceled)
